(19) United States
(12) Patent Application Publication
(10) Pub. No.: US 2022/0089170 A1
(43) Pub. Date: Mar. 24, 2022

(54) SYSTEMS AND METHODS FOR MONITORING A VEHICLE

(71) Applicant: BEIJING VOYAGER TECHNOLOGY CO., LTD., Beijing (CN)

(72) Inventors: Da Hu, Beijing (CN); Fenglei Wang, Beijing (CN)

(73) Assignee: BEIJING VOYAGER TECHNOLOGY CO., LTD., Beijing (CN)

(21) Appl. No.: 17/643,169

(22) Filed: Dec. 7, 2021

Related U.S. Application Data
(63) Continuation of application No. PCT/CN2019/091185, filed on Jun. 14, 2019.

(51) Int. Cl. B60W 50/02; B60W 60/00; B60W 50/04; B60W 50/14

(52) U.S. Cl. CPC B60W 50/0205; B60W 60/005; B60W 2050/0215; B60W 50/04; B60W 50/14; B60W 60/001

(57) ABSTRACT

The present disclosure relates to vehicle systems and methods. A system may determine first status information of one or more hardware components in a vehicle, together with second status information of one or more software components in the vehicle. The one or more software components may function at least partially depending on the one or more hardware components. The system may also convey a first notification indicating the first abnormal condition to a passenger in the vehicle in response to a determination that the first status information includes a first abnormal condition. The system may also convey a second notification indicating the second abnormal condition to the passenger in the vehicle in response to a determination that the second status information includes a second abnormal condition. The second notification may be distinct from the first notification.

### CROSS-REFERENCE TO RELATED APPLICATIONS

This application is a Continuation of International Application No. PCT/CN2019/091185, filed on Jun. 14, 2019, the entire contents of which are hereby incorporated by reference.

### TECHNICAL FIELD

The present disclosure generally relates to systems and methods for monitoring of a vehicle, and specifically, to systems and methods for informing a passenger with one or more abnormal conditions of a vehicle operating in an autonomous driving mode.

### BACKGROUND

In an autonomous driving system, each part of a vehicle, including a hardware component or a software component, may run into various abnormal conditions in different occasions. When the vehicle is operating in the autonomous driving mode, it is important to provide a system and method to timely notify the passenger in the vehicle of the abnormal condition(s) such that the passenger may judge whether to switch the autonomous driving mode to the manual driving mode.

### SUMMARY

According to an aspect of the present disclosure, a system for monitoring a vehicle is provided. The system may include at least one storage medium storing a set of instructions and at least one processor configured to communicate with the at least one storage medium. When executing the set of instructions, the at least one processor may be directed to cause the system to determine first status information of one or more hardware components in a vehicle, together with second status information of one or more software components in the vehicle. The one or more software components may function at least partially depending on the one or more hardware components. The at least one processor may be further directed to cause the system to convey, in response to a determination that the first status information includes a first abnormal condition of the one or more hardware components, a first notification indicating the first abnormal condition to a passenger in the vehicle. The at least one processor may be further directed to cause the system to perform, in response to a determination that the first status information does not include the first abnormal condition of the one or more hardware components, a first action. The at least one processor may be further directed to cause the system to convey, in response to a determination that the second status information includes a second abnormal condition of the one or more software components, a second notification, which is distinct from the first notification, indicating the second abnormal condition to the passenger in the vehicle. The at least one processor may be further directed to cause the system to perform, in response to a determination that the second status information does not include the second abnormal condition of the one or more software components, a second action.

In some embodiments, the one or more hardware components may include an electronic component, and to determine the first status information of the electronic component, the at least one processor may be directed to cause the system to determine a voltage of the electronic component via a power supply board that is configured to supply powers to the one or more hardware components in the vehicle. The at least one processor may be further directed to cause the system to determine the first status information of the electronic component based on the voltage of the electronic device.

In some embodiments, the first abnormal condition may include that the voltage of the electronic component is above or below a threshold.

In some embodiments, the one or more hardware components may include at least one sensor configured to monitor a surrounding of the vehicle, and to determine the first status information of the at least one sensor, the at least one processor may be directed to cause the system to acquire data from the at least one sensor via a first bypass circuit coupled to the at least one sensor. The at least one processor may be directed to cause the system to determine the first status information of the at least one sensor based on the acquired data from the at least one sensor.

In some embodiments, the first abnormal condition may include a failure of one of the at least one sensor.

In some embodiments, the one or more software components may include an operating system implemented on at least one of the one or more hardware components.

In some embodiments, to determine the second status information of the operating system, the at least one processor may be directed to cause the system to identify a CPU utilization of the operating system. The at least one processor may be further directed to cause the system to determine the second status information of the operating system based on the CPU utilization of the operation system.

In some embodiments, the at least one processor may be further directed to cause the system to test the operating system before switching the vehicle to an autonomous mode.

In some embodiments, the one or more software components may include at least one of a route planning program and a perception program.

In some embodiments, to determine the second status information of the route planning program or the perception program, the at least one processor may be directed to cause the system to determine whether a loss of data collected by at least one of the one or more hardware components occurs.

In some embodiments, the second abnormal condition may include the loss of data collected by the at least one of the one or more hardware components.

In some embodiments, the first notification may include an illumination of a portion of the vehicle with a preset color.

In some embodiments, the second notification may include a status indicator indicating an urgency degree of the second abnormal condition.

In some embodiments, the status indicator may indicate different urgency degrees with different colors.

In some embodiments, the at least one processor may be further directed to cause the system to acquire data from a control bus in the vehicle via a second bypass circuit. The at least one processor may be further directed to cause the system to determine, by the second bypass circuit, whether the vehicle is operating in an autonomous mode based on the acquired data from the control bus.

According to another aspect of the present disclosure, a method for monitoring a vehicle is provided. The method may include determining first status information of one or more hardware components in a vehicle, together with second status information of one or more software components in the vehicle. The one or more software components may function at least partially depending on the one or more hardware components. The method may further include conveying, in response to a determination that the first status information includes a first abnormal condition of the one or more hardware components, a first notification indicating the first abnormal condition to a passenger in the vehicle. The method may further include performing, in response to a determination that the first status information does not include the first abnormal condition of the one or more hardware components, a first action. The method may further include conveying, in response to a determination that the second status information includes a second abnormal condition of the one or more software components, a second notification, which is distinct from the first notification, indicating the second abnormal condition to the passenger in the vehicle. The method may further include performing, in response to a determination that the second status information does not include the second abnormal condition of the one or more software components, a second action.

According to still a further aspect of the present disclosure, a non-transitory computer readable medium is provided. The non-transitory computer readable medium storing instructions, the instructions, when executed by a computer, may cause the computer to implement a method. The method may include one or more of the following operations. The method may include determining first status information of one or more hardware components in a vehicle, together with second status information of one or more software components in the vehicle. The one or more software components may function at least partially depending on the one or more hardware components. The method may further include conveying, in response to a determination that the first status information includes a first abnormal condition of the one or more hardware components, a first notification indicating the first abnormal condition to a passenger in the vehicle. The method may further include performing, in response to a determination that the first status information does not include the first abnormal condition of the one or more hardware components, a first action. The method may further include conveying, in response to a determination that the second status information includes a second abnormal condition of the one or more software components, a second notification, which is distinct from the first notification, indicating the second abnormal condition to the passenger in the vehicle. The method may further include performing, in response to a determination that the second status information does not include the second abnormal condition of the one or more software components, a second action.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a block diagram illustrating an exemplary autonomous driving system according to some embodiments of the present disclosure;

FIG. 2 is a schematic diagram illustrating exemplary hardware and software components of a computing device according to some embodiments of the present disclosure;

FIG. 3 is a schematic diagram illustrating exemplary hardware and/or software components of a mobile device according to some embodiments of the present disclosure;

FIG. 4 is a block diagram illustrating an exemplary built-in computer according to some embodiments of the present disclosure;

FIG. 5 is a flowchart illustrating an exemplary process for conveying notifications to a passenger according to some embodiments of the present disclosure;

FIG. 6A and FIG. 6B are schematic diagrams illustrating exemplary user interfaces according to some embodiments of the present disclosure;

FIG. 7A and FIG. 7B are schematic diagrams illustrating exemplary user interfaces according to some embodiments of the present disclosure; and

FIG. 8 is a schematic diagram illustrating the relationship between error codes and abnormal conditions according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, section or assembly of different level in ascending order. However, the terms may be displaced by another expression if they achieve the same purpose.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or other storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in a firmware, such as an erasable programmable read-only memory (EPROM). It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that when a unit, engine, module or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

An aspect of the present disclosure relates to systems and methods for monitoring the health condition of a vehicle operating in an autonomous driving mode. The health condition of the vehicle may relate to the status of one or more components of the vehicle. For example, the systems and methods may determine the status information of one or more hardware components (e.g., an electronic component, a camera, a LiDAR, a Global Positioning System (GPS) receiver, one or more IMU (Inertial Measurement Unit) sensors) and one or more software components (e.g., an operating system of the built-in computer, a route planning program implemented on the built-in computer, a perception program implemented on the built-in computer) associated with the vehicle. The status information may include a normal condition or an abnormal condition of the one or more components of the vehicle. In the case of an abnormal condition, the systems and methods may convey a notification to a passenger (e.g., an operator) in the vehicle to remind the passenger of the abnormal condition. In this way, the systems and methods of the present disclosure may provide the passenger in the vehicle with instant information related to the health condition of the vehicle, thus helping the passenger to better judge whether to switch the driving mode of the vehicle (e.g., from an autonomous driving mode to a manual driving mode, or from the manual driving mode to the autonomous driving mode).

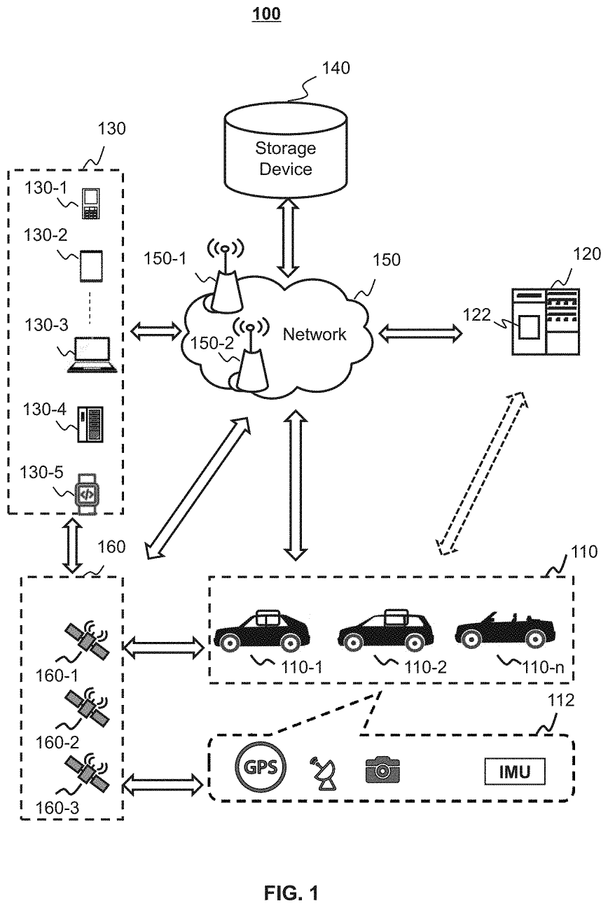

FIG. 1 is a block diagram illustrating an exemplary autonomous driving system 100 according to some embodiments of the present disclosure. In some embodiments, the autonomous driving system 100 may be applied to different autonomous or partially autonomous systems including but not limited to autonomous vehicles, advanced driver assistance systems, robots, intelligent wheelchairs, or the like, or any combination thereof. In a partially autonomous system, some functions can optionally be manually controlled by an operator. Further, a partially autonomous system can be configured to switch between a fully manual operation mode and a partially-autonomous and/or a fully-autonomous operation mode. The autonomous or partially autonomous system may be configured to operate for transportation, operate for map data acquisition, or operate for sending and/or receiving an express. In some embodiments, the autonomous driving system 100 may include one or more vehicles 110 (vehicles 110-1, 110-2 . . . 110-n), a server 120, one or more terminal device(s) 130, a storage device 140, a network 150, and a navigation system 160.

The vehicle(s) 110 may carry a passenger (e.g., an operator of the vehicle) to travel to a destination. In some embodiments, the vehicle(s) 110 may be an autonomous vehicle. The autonomous vehicle may refer to a vehicle that is capable of achieving a certain level of driving automation. Exemplary levels of driving automation may include a first level at which the vehicle is mainly supervised by a human and a specific function (e.g., steering or accelerating) of the vehicle can be performed autonomously, a second level at which the vehicle has one or more advanced driver assistance systems (ADAS) (e.g., an adaptive cruise control system, a lane-keep system) that can control the braking, steering, and/or acceleration of the vehicle, a third level at which the vehicle is able to drive autonomously when one or more certain conditions are met, a fourth level at which the vehicle can operate without human input or oversight but still is subject to some constraints (e.g., be confined to a certain area), a fifth level at which the vehicle can operate autonomously under all circumstances, or the like, or any combination thereof.

In some embodiments, the vehicle(s) 110 may be an electric vehicle, a fuel cell vehicle, a hybrid vehicle, a conventional internal combustion engine vehicle, or any other type of vehicle. The vehicle(s) 110 may include one or more similar components as a conventional vehicle, for example, a chassis, a suspension, a steering device (e.g., a steering wheel), a brake device (e.g., a brake pedal), an accelerator, etc. The vehicle(s) 110 may be an all-wheel drive (AWD) vehicle, a front-wheel drive (FWR) vehicle, or a rear-wheel drive (RWD) vehicle. In some embodiments, the vehicle(s) 110 may be configured to be operated by a passenger (e.g., an operator) riding the vehicle, under a remote control, and/or autonomous. In some embodiments, the vehicle(s) 110 may be a survey vehicle configured for acquiring data for constructing a high-definition map or 3-D city modeling.

As illustrated in FIG. 1, the vehicle(s) 110 may be equipped with a plurality of sensors 112 such that the vehicle 110 is capable of sensing its surrounding environment. The sensors 112 may be mounted on the vehicle(s) 110 via a mounting mechanism. The mounting mechanism may include an electro-mechanical device installed or otherwise attached to the body of the vehicle(s) 110. In some embodiments, the mounting mechanism may use one or more screws, adhesives, etc. The sensors 112 may be mounted on any position of the vehicle(s) 110, for example, inside or outside the body of the vehicle(s) 110.

The sensors 112 may include a camera, a radar unit, a GPS device, an inertial measurement unit (IMU) sensor, a light detection and ranging (LiDAR), or the like, or any combination thereof. The camera may be configured to obtain one or more images relating to objects (e.g., a person, an animal, a tree, a roadblock, a building, or a vehicle) that are within the view of the camera. The radar unit may utilize radio signals to sense objects in the surrounding environment of the vehicle(s) 110. In some embodiments, in addition to sensing the objects, the radar unit may also be configured to sense the speed and/or heading direction of the objects. The GPS device may be configured to receive geolocation and time information from GPS satellites and then determine the vehicle's geographical position. The IMU sensor may be configured to measure a vehicle's specific force, angular rate, and sometimes the magnetic field surrounding the vehicle, using one or more inertial sensors, such as an accelerometer and a gyroscope. In some embodiments, by combining the GPS device and the IMU sensor, the sensors 112 can provide real-time pose information of the vehicle(s) 110 as it travels, including the positions and orientations (e.g., Euler angles) of the vehicle(s) 110 at each time point. The LiDAR may be configured to scan the surrounding environment and generate data points representative of the surrounding environment. For example, the LiDAR may measure a distance to an object by illuminating the object with pulsed laser light and measuring the reflected pulses with a receiver. Differences in laser return time may then be used to make a digital 3-D representation of the object. The light used by the LiDAR device may be ultraviolet, visible, near infrared, etc.

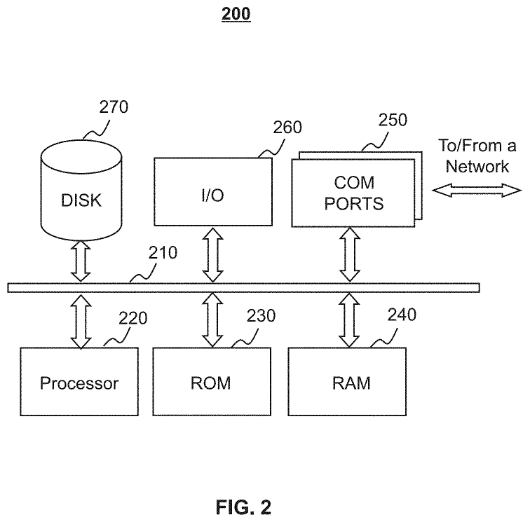

In some embodiments, the server 120 may be a single server or a server group. The server group may be centralized or distributed (e.g., the server 120 may be a distributed system). In some embodiments, the server 120 may be local to or remote from the vehicle(s) 110. The server 120 may access information and/or data stored in the terminal device(s) 130, the sensors 112, the vehicle(s) 110, the storage device 140, and/or the navigation system 160 via the network 150. Alternatively, the server 120 may be directly connected to the terminal device(s) 130, the sensors 112, the vehicle(s) 110, and/or the storage device 140 to access stored information and/or data. In some embodiments, the server 120 may be implemented on a cloud platform or an onboard computer of the vehicle(s) 110. Merely by way of example, the cloud platform may include a private cloud, a public cloud, a hybrid cloud, a community cloud, a distributed cloud, an inter-cloud, a multi-cloud, or the like, or any combination thereof, which is shared by the vehicle(s) 110. The onboard computer may be a built-in computer carried by the vehicle(s) 110. In some embodiments, the server 120 may be implemented on a computing device 200 having one or more components illustrated in FIG. 2 in the present disclosure.

In some embodiments, the server 120 may include a processing engine 122. The processing engine 122 may process information and/or data associated with the vehicle(s) 110 to perform one or more functions described in the present disclosure. For example, the processing engine 122 may obtain a physical parameter (e.g., a voltage, a current, a temperature) of one or more hardware components (e.g., the sensors 112, a circuit board). Then, the processing engine 122 may determine the status information of the one or more hardware components based on their physical parameter(s). As another example, the processing engine 122 may determine the status information of one or more software components (e.g., the operating system of the built-in computer, a specific program) by identifying an operating parameter (e.g., the CPU utilization of the operating system of the built-in computer) associated with the one or more software components. In some embodiments, the processing engine 122 may include one or more processing engines (e.g., single-core processing engine(s) or multi-core processor(s)). Merely by way of example, the processing engine 122 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

In some embodiments, the server 120 may be connected to the network 150 to communicate with one or more components (e.g., the terminal device(s) 130, the sensors 112, the vehicle(s) 110, the storage device 140, and/or the navigation system 160) of the autonomous driving system 100. In some embodiments, the server 120 may be directly connected to or communicate with one or more components (e.g., the terminal device(s) 130, the sensors 112, the vehicle(s) 110, the storage device 140, and/or the navigation system 160) of the autonomous driving system 100. In some embodiments, the server 120 may be integrated in the vehicle(s) 110. For example, the server 120 may be a computing device (e.g., a built-in computer) installed in the vehicle(s) 110.

In some embodiments, the terminal device(s) 130 may include a mobile device 130-1, a tablet computer 130-2, a laptop computer 130-3, a built-in device 130-4 in a vehicle, or the like, or any combination thereof. In some embodiments, the mobile device 130-1 may include a wearable device, a smart mobile device, a virtual reality device, an augmented reality device, or the like, or any combination thereof. In some embodiments, the wearable device may include a smart bracelet, a smart footgear, a smart glass, a smart helmet, a smart watch, smart clothing, a smart backpack, a smart accessory, or the like, or any combination thereof. In some embodiments, the smart mobile device may include a smartphone, a personal digital assistant (PDA), a gaming device, a navigation device or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google™ Glass, an Oculus Rift, a HoloLens, a Gear VR, etc. In some embodiments, the built-in device 130-4 in the vehicle may include an onboard display, an indicating light, a speaker, etc. In some embodiments, the server 120 may be integrated into the terminal device(s) 130.

The terminal device(s) 130 may be configured to facilitate interactions between a user and the vehicle(s) 110. For example, the user may send a command to the vehicle(s) 110 (e.g., the built-in computer of the vehicle(s) 110) via the terminal device. As another example, the terminal device(s) 130 may receive information associated with the vehicle(s) 110 (e.g., a real-time position of the vehicle(s) 110, a status information of one or more components of the vehicle(s) 110) from, for example, the built-in computer of the vehicle(s) 110. The status information of a specific component in the vehicle(s) 110 may indicate whether the specific component is working in a normal condition or an abnormal condition. Specifically, in the case of an abnormal condition of the specific component, the status information may further indicate the urgency degree of the abnormal condition, or a fault type of the abnormal condition. In some embodiments, the owner of the terminal device(s) 130 may be a passenger riding the vehicle(s) 110. The passenger may instantly receive a notification about an abnormal condition of a component of the vehicle(s) 110 (e.g., a hardware component, a software component) via the terminal device(s) 130. The notification about the abnormal condition may be conveyed to the passenger in various forms. For example, the notification may be an illumination of a portion of the terminal device(s) 130. As another example, the notification may be an alert sound generated by the terminal device(s) 130. As still another example, the notification may be a warning appearing on the terminal device(s) 130. As still another example, the notification may be a message sent to the terminal device(s) 130.

The storage device 140 may store data and/or instructions. In some embodiments, the storage device 140 may store data obtained from the terminal device(s) 130, the sensors 112, the vehicle(s) 110, the navigation system 160, and/or the processing engine 122. For example, the storage device 140 may store measured data acquired by the sensors 112. As another example, the storage device 140 may store status information associated with one or more hardware components and/or one or more software components in the vehicle(s) 110. In some embodiments, the storage device 140 may store data and/or instructions that the server 120 may execute or use to perform exemplary methods described in the present disclosure. For example, the storage device 140 may store instructions that the processing engine 122 may execute or use to determine the status information of the sensors 112. As another example, the storage device 140 may store instructions that the processing engine 122 may execute or use to determine whether the status information associated with one or more hardware components and/or one or more software components in the vehicle(s) 110 include abnormal conditions.

In some embodiments, the storage device 140 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 140 may be connected to the network 150 to communicate with one or more components (e.g., the server 120, the terminal device(s) 130, the sensors 112, the vehicle(s) 110, and/or the navigation system 160) of the autonomous driving system 100. In some embodiments, the storage device 140 may be directly connected to or communicate with one or more components (e.g., the server 120, the terminal device(s) 130, the sensors 112, the vehicle(s) 110, and/or the navigation system 160) of the autonomous driving system 100. In some embodiments, the storage device 140 may be part of the server 120. In some embodiments, the storage device 140 may be integrated in the vehicle(s) 110.

The network 150 may facilitate exchange of information and/or data. In some embodiments, one or more components (e.g., the server 120, the terminal device(s) 130, the sensors 112, the vehicle(s) 110, the storage device 140, or the navigation system 160) of the autonomous driving system 100 may send information and/or data to other component(s) of the autonomous driving system 100 via the network 150. For example, the server 120 may receive the measured data from the sensors 112 via the network 150. In some embodiments, the network 150 may be any type of wired or wireless network, or combination thereof. Merely by way of example, the network 150 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 150 may include one or more network access points. For example, the network 150 may include wired or wireless network access points, through which one or more components of the autonomous driving system 100 may be connected to the network 150 to exchange data and/or information.

The navigation system 160 may determine information associated with an object, for example, one or more of the terminal device(s) 130, the vehicle(s) 110, etc. In some embodiments, the navigation system 160 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, or a current time. The navigation system 160 may include one or more satellites, for example, a satellite 160-1, a satellite 160-2, and a satellite 160-3. The satellites 170-1 through 170-3 may determine the information mentioned above independently or jointly. The satellite navigation system 160 may send the information mentioned above to the network 150, the terminal device(s) 130, or the vehicle(s) 110 via wireless connections.

It should be noted that the autonomous driving system 100 is merely provided for the purposes of illustration, and is not intended to limit the scope of the present disclosure. For persons having ordinary skills in the art, multiple variations or modifications may be made under the teachings of the present disclosure. For example, the autonomous driving system 100 may further include a database, an information source, etc. In some embodiments, the GPS device may also be replaced by other positioning device, such as BeiDou. However, those variations and modifications do not depart from the scope of the present disclosure.

FIG. 2 illustrates a schematic diagram of an exemplary computing device 200 according to some embodiments of the present disclosure. The computing device 200 may be a computer, such as the server 120 in FIG. 1 and/or a built-in computer of a vehicle with specific functions as described elsewhere in the present disclosure. The computing device 200 may be configured to implement any component of the autonomous driving system 100 as described in the present disclosure. For example, the server 110 and/or the terminal device(s) 130 may be implemented on the computing device 200, via its hardware, software programs, firmware, or any combination thereof of. Although only one such computing device is shown, for convenience, the computer functions relating to the autonomous driving system 100 as described herein may be implemented in a distributed fashion on a number of similar platforms, to distribute the processing load. As illustrated in FIG. 2, the computing device 200 may include a communication bus 210, a processor 220, a storage device, an input/output (I/O) 260, and a communication port 250. The processor 220 may execute computer instructions (e.g., program code) and perform functions of one or more components of the autonomous driving system 100 in accordance with techniques described herein. For example, the processor 220 may determine the status information of one or more hardware components or software components of the vehicle(s) 110, and notify a passenger the status information via various manners. The computer instructions may include, for example, routines, programs, objects, components, data structures, procedures, modules, and functions, which perform particular functions described herein. In some embodiments, the processor 220 may include interface circuits and processing circuits therein. The interface circuits may be configured to receive electronic signals from the communication bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the communication bus 210.

In some embodiments, the processor 220 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

Merely for illustration, only one processor 220 is described in the computing device 200. However, it should be noted that the computing device 200 in the present disclosure may also include multiple processors, thus operations and/or method steps that are performed by one processor as described in the present disclosure may also be jointly or separately performed by the multiple processors. For example, if in the present disclosure the processor of the computing device 200 executes both step A and step B, it should be understood that step A and step B may also be performed by two or more different processors jointly or separately in the computing device 200 (e.g., a first processor executes step A and a second processor executes step B, or the first and second processors jointly execute steps A and B).

The storage device may store data/information related to the autonomous driving system 100. In some embodiments, the storage device may include a mass storage device, a removable storage device, a volatile read-and-write memory, a random access memory (RAM) 240, a read-only memory (ROM) 230, a disk 270, or the like, or any combination thereof. In some embodiments, the storage device may store one or more programs and/or instructions to perform exemplary methods described in the present disclosure. For example, the storage device may store a program (e.g., a route planning program, a perception program) for the processor 220 to execute.

The I/O 260 may input and/or output signals, data, information, etc. In some embodiments, the I/O 260 may enable a user interaction with the computing device 200. In some embodiments, the I/O 260 may include an input device and an output device. Examples of the input device may include a keyboard, a mouse, a touch screen, a microphone, or the like, or a combination thereof. Examples of the output device may include a display device, a loudspeaker, a printer, a projector, or the like, or a combination thereof. Examples of the display device may include a liquid crystal display (LCD), a light-emitting diode (LED)-based display, a flat panel display, a curved screen, a television device, a cathode ray tube (CRT), a touch screen, or the like, or a combination thereof.

The communication port 250 may be connected to a network (e.g., the network 150) to facilitate data communications. The communication port 250 may establish connections between the computing device 200 and one or more components of the autonomous driving system 100. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee link, a mobile network link (e.g., 3G, 4G, 5G, etc.), or the like, or a combination thereof. In some embodiments, the communication port 250 may be and/or include a standardized communication port, such as RS232, RS485, etc. In some embodiments, the communication port 250 may be a specially designed communication port.

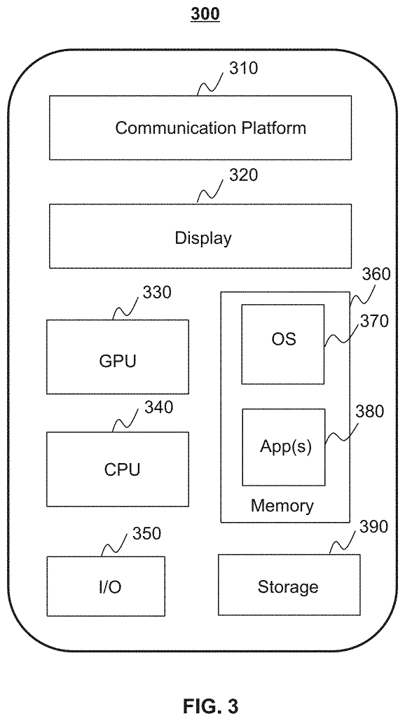

FIG. 3 is a schematic diagram illustrating exemplary hardware and/or software components of an exemplary mobile device 300 on which a terminal device may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and storage 390. In some embodiments, the display 320 may instantly display a notification about an abnormal condition of a component of the vehicle(s) 110 (e.g., a hardware component, a software component). In some embodiments, any other suitable component, including but not limited to a system bus or a controller (not shown), may also be included in the mobile device 300. In some embodiments, a mobile operating system 370 (e.g., iOS™, Android™, Windows Phone™) and one or more applications 380 may be loaded into the memory 360 from the storage 390 in order to be executed by the CPU 340. The applications 380 may include a browser or any other suitable mobile apps for receiving and rendering information relating to positioning or other information from the processing engine 122. User interactions with the information stream may be achieved via the I/O 350 and provided to the processing engine 122 and/or other components of the autonomous driving system 100 via the network 150.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

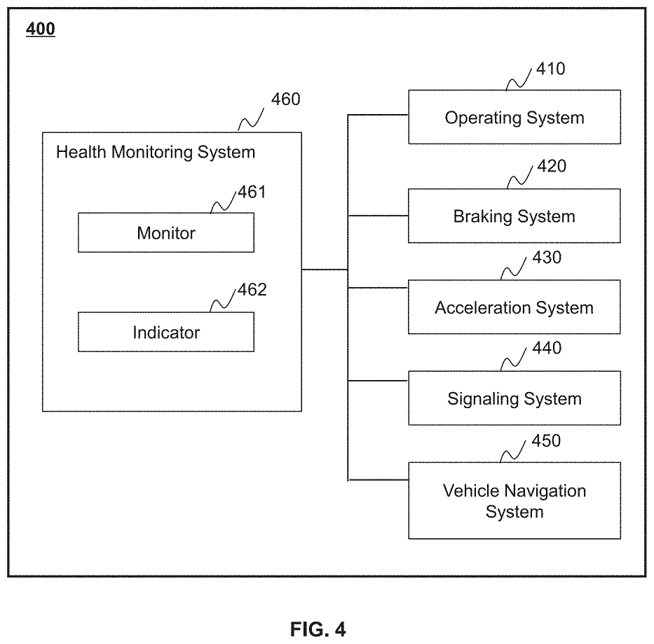

FIG. 4 is a block diagram illustrating an exemplary vehicle system 400 implemented in a vehicle according to some embodiments of the present disclosure. In some embodiments, the vehicle system 400 may include hardware/software components, or perform one or more functions as described elsewhere in the present disclosure.

As shown in FIG. 4, the vehicle system 400 may include an operating system 410, a braking system 420, an acceleration system 430, a signaling system 440, a vehicle navigation system 450, and a health monitoring system 460.

The operating system 410 may refer to a software component implemented on the vehicle. In some embodiments, the operating system 410 may manage various hardware components and other software components of the vehicle. For example, the operating system 410 may provide a platform on which one or more programs of the vehicle may be executed to achieve certain functions (e.g., the function of route planning, the function of perception of objects) based on the operation of one or more hardware components (e.g., a sensor). In some embodiments, the operating system 410 may allocate the computation resource of a processing unit (e.g., a CPU) to different software components. The performance of the operating system 410 may be measured by a utilization of the computation resource of the processing unit. A higher CPU utilization may denote a heavier burden for the processing unit. In some embodiments, if the CPU utilization exceeds a certain threshold, the operating system 410 may be deemed as working in an abnormal condition.

The braking system 420 may be configured to apply the brakes on the vehicle. In some embodiments, the braking system 420 may include a brake pad and a brake control circuit. When receiving an instruction to apply the brake (e.g., from a passenger or a built-in computer of the vehicle), the brake control circuit may actuate the brake pad to move to a position to impede the movement of the wheels of the vehicle. In some embodiments, the status information of the brake control circuit may be reflected by the voltage or current thereon. For example, if the voltage or current of the brake control circuit is above or below a threshold, the brake control circuit may be deemed as working in an abnormal condition. The threshold related to the voltage of the brake control circuit may be set to be a proportion of a rated voltage. The proportion may be any value less than 1, such as 1%, 2%, 3%, 4%, 5%, 6%, 10%, 20%, etc. In some embodiments, the status information of the brake control circuit may be reflected by the temperature of its circuit board. If the temperature of the circuit board is above a temperature threshold, the brake control circuit may be deemed as working in an abnormal condition.

The acceleration system 430 may be configured to accelerate the vehicle. In some embodiments, the acceleration system 430 may include an acceleration pedal and an acceleration control circuit. When receiving an instruction to accelerate the vehicle (e.g., from a passenger or a built-in computer of the vehicle), the acceleration control circuit may accelerate the vehicle by applying a force on the acceleration pedal. In some embodiments, the status information of the acceleration control circuit may be reflected by the voltage or current thereon. For example, if the voltage or current of the brake control circuit is above or below a threshold, the acceleration control circuit may be deemed as working in an abnormal condition. The threshold related to the voltage of the acceleration control circuit may be set to be a proportion of a rated voltage. The proportion may be any value less than 1, such as 1%, 2%, 3%, 4%, 5%, 6%, 10%, 20%, etc. In some embodiments, the braking system 420 and the acceleration system 430 may cooperate to control the speed of the vehicle under the instructions of, for example, a built-in computer of the vehicle as described elsewhere in the present disclosure.

The signaling system 440 may be configured to receive and/or send a signal to an external device. In some embodiments, the external device may include one or more components in the autonomous driving system 100 (e.g., the terminal device(s) 130, the storage device 140, the navigation system 160). The external device may include one or more devices in the surrounding environment of the vehicle, such as, a traffic light, another vehicle, etc. In some embodiments, the signal system 440 may include a receiver. The status information of the receiver may be reflected by the voltage or current thereon. For example, if the voltage or current of the receiver is above or below a threshold, the receiver may be deemed as working in an abnormal condition. The threshold related to the voltage of the receiver may be set to be a proportion of a rated voltage. The proportion may be any value less than 1, such as 1%, 2%, 3%, 4%, 5%, 6%, 10%, 20%, etc. In some embodiments, the status information of the receiver may be reflected by the temperature thereof. If the temperature of the receiver is above a temperature threshold, the receiver may be deemed as working in an abnormal condition.

The vehicle navigation system 450 may be configured to control the navigation of the vehicle. In some embodiments, the vehicle navigation system 450 may be part of the navigation system 160 described in FIG. 1 and may be implemented by the built-in computer of the vehicle. The navigation system 450 may include one or more software components that are executable to realize various functions. For example, the navigation system 450 may include a specific software component that includes a first program to locate the position of the vehicle and a second program to plan the route of the vehicle. The operation of the first software component may depend on one or more hardware components of the vehicle. For example, to execute the first program to locate the position of the vehicle, the specific software component may use the data from the receiver of the signaling system 440, which acquires the position information of the vehicle from a satellite. As another example, to execute the second program to plan the route of the vehicle, the specific software component may use the data collected by one or more sensors of the vehicle. The status information of the vehicle navigation system 450 may be correlated with the status information of the software component(s) thereof. In some embodiments, if the software component fails to run caused by, for example, a loss of data collected by the associated hardware component(s), the vehicle navigation system 450 (or the software component thereof) may be deemed abnormal.

The health monitoring system 460 may be configured to monitor the working condition of one or more hardware components and software components of the vehicle. For illustration purpose, as shown in FIG. 4, the health monitoring system 460 may include a monitor 461 and an indicator 462.

The monitor 461 may monitor the status of the operating system 410, the status of the braking system 420, the status of the acceleration system 430, the status of the signaling system 440, the status of the vehicle navigation system 450, or the like, or a combination thereof, to detect possible errors or failures that may affect the autonomous driving of the vehicle. Specifically, the monitor 461 may retrieve data corresponding to the working status of one or more electronic components (e.g. a GPS sensor, an IMU sensor, a camera, etc.) by a bypass circuit, and determine whether the one or more electronic components are working in a normal status. As used herein, the one or more electronic components may be deemed as hardware component(s) of the vehicle. A bypass circuit may include a single chip microcomputer (SCM) that is capable of processing data independently. The data corresponding to the working status of the one or more electronic components may include a physical parameter (e.g., a voltage, a current, a temperature) of the one or more electronic components. Additionally or alternatively, the monitor 461 may retrieve the operating parameter of one or more software components to determine whether the one or more software components are working in a normal status. The operating parameter of a software component may include a piece of code (e.g., an error code).

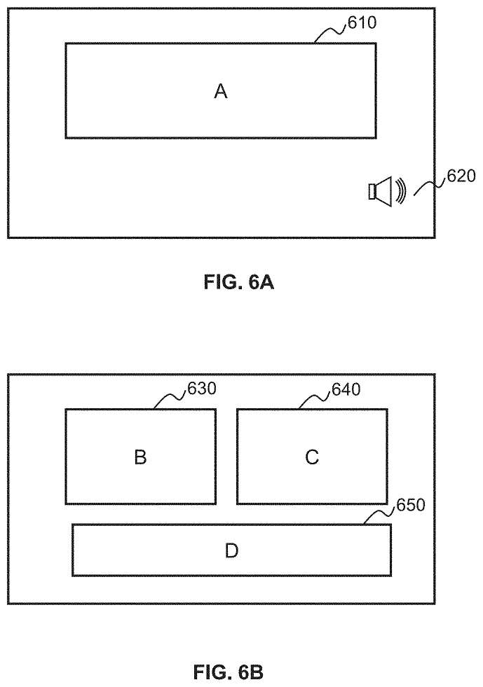

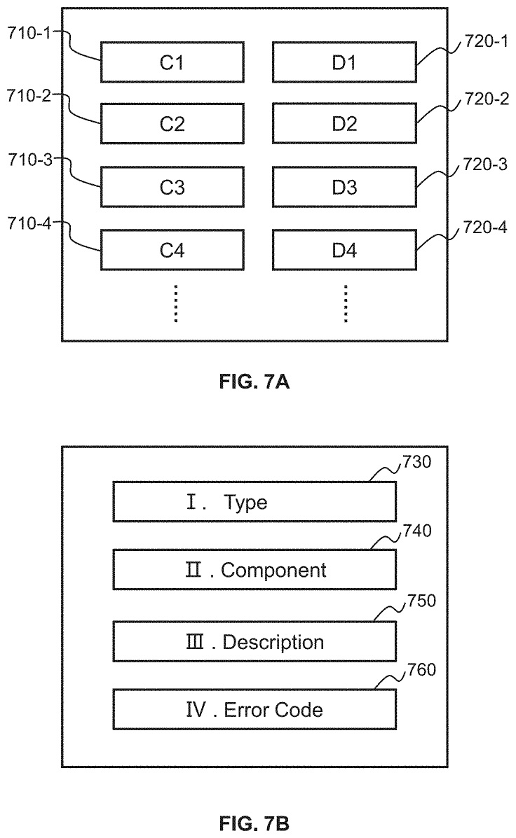

The indicator 462 may be configured to notify the status of the one or more hardware components and/or software components to a passenger in the vehicle (e.g., an operator). For example, the indicator 462 may use a visual or audible cue to indicate whether an abnormal condition occurs. In some embodiments, the indicator 462 may generate the visual or audible cue only if an error of a hardware component or a software component occurs. In some embodiments, the indicator 462 may generate a first visual or audible cue to indicate that the one or more hardware components and/or software components are working in a normal status, and generate a second visual or audible cue, distinct from the first visual or audible cue, to indicate that an error occurs on the one or more hardware components and/or software components. For example, a normal status of a hardware/software component may be indicated by a first color, and an abnormal status of the hardware/software component may be indicated by a second color distinct from the first color. In some embodiments, for different hardware/software components, the indicator 462 may generate different visual or audible cues to indicate their status, respectively. For example, an error of a hardware may be conveyed to the passenger via an audible cue (e.g., an alarm sound), and a failure of a software component may be conveyed to the passenger via the onboard display of the vehicle. More details regarding the notification about the status may be found elsewhere in the present disclosure (e.g., FIGS. 6A, 6B, 7A, 7B, and the description thereof).

In some embodiments, the monitor 461 may monitor the driving mode of the vehicle. For example, the monitor 461 may retrieve, via a bypass circuit (e.g., a board card), data from a system bus (e.g., the communication bus 210) of the built-in computer that includes the information related to the CAN (Controller Area Network) bus as described in the Automotive Standards ISO 11898(CAN). The bypass circuit may analyze the information related to the CAN bus, upon which the monitor 461 may determine whether the vehicle is working in the autonomous mode. In some embodiments, in response to the determination that the vehicle is working in the autonomous mode, the monitor 461 may instruct the indicator 462 to display the status of autonomous driving via, for example, a green light. In response to the determination that the vehicle is not working in the autonomous mode, the monitor 461 may instruct the indicator 462 to display the status of manual driving via, for example, a red light.

It should be noted that the above description of the vehicle system 400 is provided for the purposes of illustration, and is not intended to limit the scope of the present disclosure. For persons having ordinary skills in the art, multiple variations and modifications may be made under the teachings of the present disclosure. However, those variations and modifications do not depart from the scope of the present disclosure. For example, besides the systems monitored by the health monitoring system 460 as described above, the health monitoring system 460 may further monitor additional systems related to the vehicle operating in the autonomous mode, such as, a network, a storage, a user interface system, etc. And the health monitoring system 460 may similarly notify the passenger in the vehicle of any abnormal condition of the additional systems.

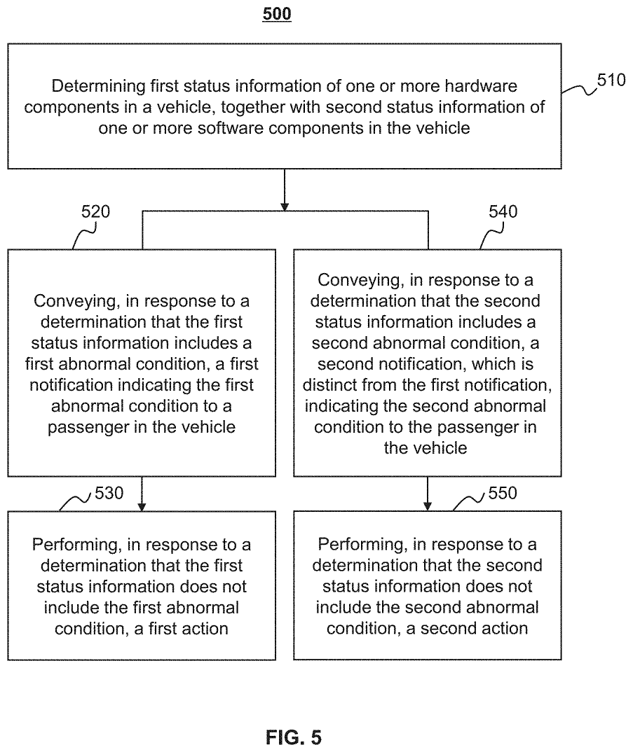

FIG. 5 is a flowchart illustrating an exemplary process for conveying notifications to a passenger according to some embodiments of the present disclosure. At least a portion of process 500 may be implemented on the computing device 200 as illustrated in FIG. 2. In some embodiments, one or more operations of process 500 may be implemented in the autonomous driving system 100 as illustrated in FIG. 1. In some embodiments, one or more operations in the process 500 may be stored in a storage device (e.g., the storage device 140, the ROM 230, the RAM 240) as a form of instructions, and invoked and/or executed by the server 120 or a built-in computer of the vehicle 110 (e.g., the processing engine 122 in the server 120, or the processor 220 of the computing device 200). In some embodiments, the instructions may be transmitted in a form of electronic current or electrical signals. The operations of the illustrated process present below are intended to be illustrative. In some embodiments, the process 500 may be accomplished with one or more additional operations not described and/or without one or more of the operations herein discussed. Additionally, the order in which the operations of the process as illustrated in FIG. 5 and described below is not intended to be limiting.

In 510, the monitor 461 may determine first status information of one or more hardware components in a vehicle, together with second status information of one or more software components in the vehicle.

In some embodiments, the one or more hardware components may include basal physical components and electronic components of a vehicle (e.g., one or more sensors mounted on the vehicle). Exemplary basal physical components and electronic components of the vehicle may include engine components, chassis components, body structure components, electric circuits, etc. The one or more sensors may include a GPS sensor, an IMU sensor, a LIDAR sensor, a camera, or the like, or any combination thereof, which may be configured to monitor the surrounding environment of the vehicle.

Taking an electronic component as an example of hardware component, the monitor 461 may monitor a voltage of the electronic component via a power supply board that is configured to supply powers to the one or more hardware components in the vehicle, and further determine the first status information (e.g. a normal condition or an abnormal condition) of the electronic component based on its voltage. As another example, the hardware component may be a sensor (e.g. a camera) mounted on the vehicle. The monitor 461 may monitor one or more physical parameters (e.g., the voltage, the current, temperature, etc.) of the sensor via a first bypass circuit coupled to the sensor. Further, the monitor 461 may determine the first status information of the sensor based on the monitored one or more physical parameters of the sensor.

In some embodiments, the one or more software components may include an operating system (OS) implemented on the built-in computer of the vehicle. The monitor 461 may identify a CPU utilization of the operating system. Further, the monitor 461 may determine the second status information of the operating system based on the CPU utilization of the operation system. In some embodiments, if the CPU utilization exceeds a certain threshold, the operating system 410 may be deemed as working in an abnormal condition. Additionally or alternatively, the monitor 461 may monitor the temperature of the CPU. If the temperature of the CPU exceeds a temperature threshold, the operating system 410 may be deemed as working in an abnormal condition. In some embodiments, before switching the vehicle to an autonomous driving mode, the monitor 461 may first test the operating system. Only if the operating system satisfies a preset condition, can the vehicle be switched to the autonomous driving mode. The preset condition may be a condition that the CPU utilization of the operation system is lower than a threshold (e.g. 50%).

In some embodiments, the one or more software components may include an application software that is executable by the built-in computer of the vehicle in the autonomous driving mode (e.g., a route planning program or a perception program). The monitor 461 may determine the second status information of the application software based on whether the data to be processed by the application software is received. In some embodiments, the data to be processed by the application software may be collected by at least one of the one or more hardware components (e.g. a sensor). If a loss of data collected by the at least one of the one or more hardware components occurs, the application software may be deemed as abnormal.

The one or more software components may function at least partially depending on the one or more hardware components. For example, the software component including the perception program may perceive the environment surrounding the vehicle based on the data measured by the one or more sensors mounded on the vehicle. As another example, the software component including the route planning program may plan the travel route based on the position information acquired by the GPS sensor of the vehicle.

In 520, the indicator 462 may convey, in response to a determination that the first status information includes a first abnormal condition, a first notification indicating the first abnormal condition to a passenger in the vehicle. In some embodiments, the first notification may include a visual or audible cue. For example, if the monitor 461 identifies a power failure of the camera, the indicator 462 may convey a voice prompt to the passenger to indicate the power failure of the camera. As another example, if the monitor 461 identifies that a voltage of a specific sensor is lower than a preset threshold, the indicator 462 may convey a visual cue to the passenger on an onboard display of the vehicle to indicate the under-voltage condition of the specific sensor. As a further example, if the processor 421 identifies that the remaining oil in the fuel tank is lower a preset threshold, the indicator 462 may convey a visual cue to the passenger to indicate the condition of insufficient oil. In some embodiments, the visual cue may be an illumination generated by one or more indicating lights, or include a textual description displayed on the onboard display of the vehicle.

In some embodiments, the first notification may also indicate an urgency degree of the first abnormal condition. For example, if the first notification is an audible cue of a voice prompt, the voice prompt may include one or more words indicating the urgency degree. The words similar to “abnormality” or “error” may indicate a high urgency degree, and the words similar to “notification” and “warning” may indicate a low urgency degree. As another example, if the first notification is a textual description, the size, color, background color, etc. of the textual description may be used to indicate the urgency degree of the first abnormal condition. As a further example, if the first notification is a visual cue provided by one or more indicating lights, the color and/or the number of illuminated indicating lights may indicate the urgency degree of the first abnormal condition.

In 530, the indicator 462 may perform, in response to a determination that the first status information does not include the first abnormal condition, a first action. In some embodiments, similar to conveying the first notification to the passenger, the first action may also include conveying a third notification, which is different from the first notification, to the passenger. For example, in the case that the third notification is a textual description, a green background of the textual description may be applied to indicate that no first abnormal condition occurs. In some embodiments, that the indicator 462 performs the first action may denote that no action is performed by the indicator 462, which means that no visual or audible cue is generated when the one or more hardware components are working in the normal status.

In 540, the indicator 462 may convey, in response to a determination that the second status information includes a second abnormal condition, a second notification indicating the second abnormal condition to the passenger in the vehicle.

The second notification may be distinct from the first notification described above. In some embodiments, the second notification and the first notification (if any) may be independently conveyed to the passenger. For example, the first notification may be an audible cue (e.g., a voice prompt) played by a speaker of the vehicle, and the second notification may be a visual cue (e.g., a textual description, or an indicating light) displayed on a display of the vehicle. For another example, the first notification and the second notification may both be visual cues, but displayed on different portions of the onboard display of the vehicle. The first notification may be displayed on the left portion of the onboard display and the second notification may be displayed on the right portion of the onboard display.

In some embodiments, an independent indicating light may be used to indicate the urgency degree of an abnormal condition (e.g., the first abnormal condition, the second abnormal condition). The independent indicating light may be illuminated on occurrence that an abnormal condition with a high urgency degree which may affect the autonomous driving of the vehicle may occur. In this case, the passenger in the vehicle may be urged to take instant action, such as, manually control the vehicle.

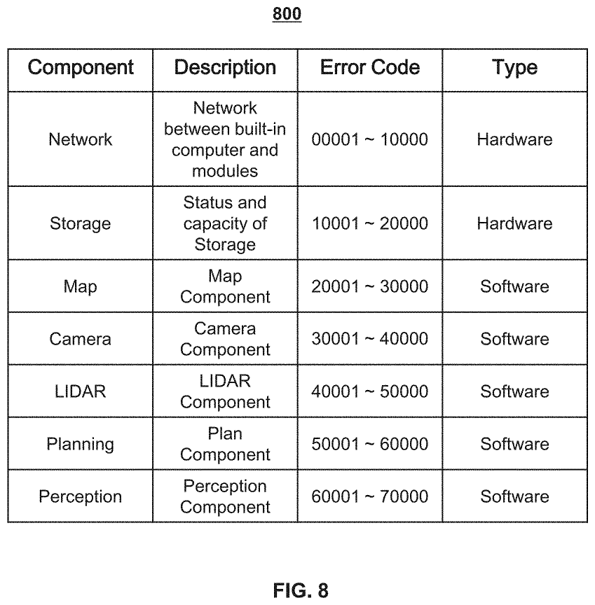

In some embodiments, the second abnormal condition may be accompanied with an error code that designates the specific software component in which the second abnormal condition occurs. Additionally or alternatively, the error code may indicate the urgency degree of the second abnormal condition according a preset rule. An example illustrating the error code may be found elsewhere in the present disclosure (e.g., FIG. 8, and the description thereof).

In 550, the indicator 462 may perform, in response to a determination that the second status information does not include the second abnormal condition, a second action. In some embodiments, similar to conveying the second notification to the passenger, the second action may also include conveying a fourth notification, which is different from the second notification, to the passenger. For example, in the case that the fourth notification is a textual description, a green background of the textual description may be applied to indicate that no second abnormal condition occurs. In some embodiments, that the indicator 462 performs the second action may denote that no action is performed by the indicator 462, which means that no visual or audible cue is generated when the one or more software components are working in the normal status.

It should be noted that the above description regarding the process 500 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be omitted and/or one or more additional operations may be added. For example, the operation 520 or the operation 540 may be omitted such that only the status information of the hardware components or the software components may be monitored and conveyed to the passenger in the vehicle.

FIG. 6A and FIG. 6B are schematic diagrams illustrating exemplary user interfaces according to some embodiments of the present disclosure. In some embodiments, the user interfaces may be implemented on the built-in computer of the vehicle 110, or the terminal device 130.

FIG. 6A shows the user interface conveying a notification indicating an abnormal condition to the passenger. As shown in FIG. 6A, a visual cue 610 and an audible cue 620 are used to convey the notification to the passenger. In some embodiments, the visual cue 610 may include a textual description with a background of a specific color. The content of the textual description may describe the abnormal condition included in the status information. For example, the textual description may describe a specific hardware component (e.g., the name of the hardware component, the ID of the hardware component, the function of the hardware component) or a specific software component (e.g., the name of the software component, the ID of the software component, the function of the software component). The color of the background may relate to the urgency degree of the abnormal condition. For example, a red background may represent that the urgency degree of the abnormal condition is critical. A yellow background may represent that the urgency degree of the abnormal condition is moderate (i.e., not critical). For illustration purpose, the visual cue 610 may show a textual description of “hardware error: GPS sensor power” with yellow background. In this situation, the visual cue 610 may indicate that the GPS sensor is abnormal due to its power failure. The urgency degree is not critical and no instant action by the passenger is required. As another example, when no visual cue is displayed, it denotes that no abnormal condition occurs.

In some embodiments, the audible cue 620 may be a voice prompt. The content of the voice prompt may indicate the abnormal condition included in the status information. The volume level, background sound, playback mode, etc. of the voice prompt may indicate the urgency degree of the abnormal condition. For example, when a voice prompt containing a content of “Insufficient Oil” is played with a normal volume level, it may denote an abnormal condition of the remaining oil in the fuel tank (e.g., the remaining oil is less than a preset threshold). The urgency degree of this abnormal condition is not critical and it may not affect the autonomous driving of the vehicle. As another example, when a voice prompt containing a content of “route planning failure” is repeatedly played, it may denote an abnormal condition of the route planning program. The urgency degree of this abnormal condition is critical and it may seriously affect the autonomous driving of the vehicle.

In some embodiments, the visual cue 610 and the audible cue 620 may be combined to convey a notification indicating the abnormal condition to the passenger. For example, the visual cue 610 may be an indicating light with different colors, such as red, yellow and green. Different colors of the indicating light may indicate different urgency degrees. The audible cue 620 may be a voice prompt indicating the component in the abnormal condition. If the indicating light is illuminated with the color of red and the voice prompt contains a content of “navigation software failure”, it may denote a critical failure of the navigation software component.

As shown in FIG. 6B, three visual cues 630, 640 and 650 are used to convey the notification to the passenger. The visual cue 630 and the visual cue 640 may indicate two different abnormal conditions, respectively. The visual cue 650 may indicate a comprehensive urgency degree based on the two different abnormal conditions. In some embodiments, the comprehensive urgency degree may reflect the overall condition for the vehicle. For example, the visual cue 630 may include a textual description with the content of a hardware component and a red background. The visual cue 640 may include another textual description with the content of a software component and a green background. The visual cue 650 may be in red color. In such case, it may denote that an abnormal condition of the hardware component and an abnormal condition of the software component may exist simultaneously in the vehicle. The urgency degree of the abnormal condition of the hardware is critical, and the urgency degree of the abnormal condition of the software is moderate. The comprehensive urgency degree of the abnormal condition for the vehicle is critical, and the passenger in the vehicle may be urged to take instant action, such as, manually control the vehicle.

It should be noted that the above description of the user interfaces in FIG. 6A and FIG. 6B are provided for the purposes of illustration, and is not intended to limit the scope of the present disclosure. For persons having ordinary skills in the art, multiple variations and modifications may be made under the teachings of the present disclosure. However, those variations and modifications do not depart from the scope of the present disclosure. For example, in FIG. 6B, an audible cue may be used to indicate the comprehensive urgency degree instead of the visual cue 650.

FIG. 7A and FIG. 7B are schematic diagrams illustrating exemplary user interfaces according to some embodiments of the present disclosure.

FIG. 7A shows the user interface conveying a notification indicating one or more abnormal conditions to the passenger. As shown in FIG. 7A, a plurality of first visual cues (e.g. a visual cue 710-1, a visual cue 710-2, a visual cue 710-3, and a visual cue 710-4) and a plurality of second visual cues (e.g. a visual cue 720-1, a visual cue 720-2, a visual cue 720-3, and a visual cue 720-4) are arranged to jointly convey the notification to the passenger. The first visual cues may indicate the abnormal conditions of different components (e.g., different hardware components or software components) in the vehicle. The urgency degree of each of the abnormal conditions may be indicated by the second visual cues. For example, the first visual cue 710-1 may include a textual description with the content of “Receiver”. The first visual cue 710-2 may include a textual description with the content of “GPS sensor”. The first visual cue 710-3 may include a textual description with the content of “Operating System”. The first visual cue 710-4 may include a textual description with the content of “Route Planning”. The second visual cues 720-1 to 720-4 may include indicating lights with colors of green, yellow, red, and yellow, respectively. In this situation, four abnormal conditions of different components may be conveyed to the passenger. The four abnormal conditions may be the failure of the hardware component “Receiver”, the failure of the hardware component “GPS sensor”, the failure of the software component “Operating System”, and the failure of the software component “Route Planning”, among which the abnormal condition of the operating system is critical.

As shown in FIG. 7B, four visual cues (e.g. a visual cue 730, a visual cue 740, a visual cue 750, and a visual cue 760) are arranged to jointly convey the notification to the passenger. The visual cue 730 may indicate the type of the abnormal component, such as whether the component is a hardware component or a software component. The visual cue 740 may indicate the specific component in the abnormal condition. The specific component may include the network component, the storage component, the map component, the camera component, the LIDAR component, the planning component, the perception component, or the like, or any combination thereof. The visual cue 750 may indicate the details of the abnormal condition. The details of the abnormal condition may include the specific problem, such as network disconnected, overheat, under-voltage, no GPS signal, or the like, or any combination thereof. The visual cue 760 may indicate the error code of the abnormal condition. The error code of the abnormal condition may represent the urgency degree of the abnormal condition. In some embodiments, each possible abnormal condition may correspond to a multi-digit (e.g. five digit) error code. One or more digits in the multi-digit error code may be used to represent the urgency degree of the abnormal condition. Taking a five digit error code as an example, the last four digits of the error code may be used to represent the urgency degree of the abnormal condition. If the last four digits of the error code is in the range of 1 to 2999, the error code may represent a “critical” abnormal condition. If the last four digits of the error code is in the range of 3000 to 5999, the error code may represent a “slightly critical” abnormal condition. If the last four digits of the error code is in the range of 6000 to 9999, the error code may represent a “moderate” abnormal condition.

It should be noted that the above description of the user interfaces in FIG. 7A and FIG. 7B are provided for the purposes of illustration, and is not intended to limit the scope of the present disclosure. For persons having ordinary skills in the art, multiple variations and modifications may be made under the teachings of the present disclosure. However, those variations and modifications do not depart from the scope of the present disclosure. For example, in FIG. 7A, each of the second visual cues may include three indicating lights. The urgency degree may be represented by the number of the simultaneously illuminated indicating lights. When only one indicating light is illuminated, the abnormal condition may be regarded as “moderate”. When two of the three indicating lights are illuminated, the abnormal condition may be regarded as “slightly critical”. When all the three indicating lights are illuminated, the abnormal condition may be regarded as “critical”. As another example, in FIG. 7B, the error code may not be necessarily displayed on the user interface. Instead, the error code may be stored in a storage device (e.g., the storage device 140, the ROM 230, the RAM 240) for subsequent analysis by, for example, a technician.

FIG. 8 is a schematic diagram illustrating the relationship between error codes and abnormal conditions according to some embodiments of the present disclosure.

As shown in FIG. 8, seven abnormal conditions are listed in the table, along with their descriptions and types. For example, the abnormal conditions of the network component are assigned with the error codes ranging from “00001” to “10000”. In this case, the network component may run into different abnormal conditions with different urgency degrees, and each abnormal condition of the network component may correspond to a distinctive error code. In some embodiments, if the last four digits of the error code is in the range of 1 to 2999, which means that the whole error code of the network component is in the range of “10001” to “12999”, the error code may represent that the network component is in a “critical” abnormal condition. If the last four digits of the error code is in the range of 3000 to 5999, which means that the whole error code of the network component is in the range of “13000” to “15999”, the error code may represent that the network component is in a “slightly critical” abnormal condition. If the last four digits of the error code is in the range of 6000 to 9999, which means that the whole error code of the network component is in the range of “16000” to “19999”, the error code may represent that the network component is in a “moderate” abnormal condition. The error codes of other components, such as the map component, the planning component, the perception component, may be similarly interpreted as the network component, and the description is not repeated herein.

It shall be noted that the abnormal conditions of different components may be different. For example, for the camera sensor, the abnormal conditions may include overheat and under voltage. The overheat of the camera sensor may correspond to the “moderate” abnormal condition, and the under voltage of the camera sensor may correspond to the “slightly critical” abnormal condition. For the perception component, the abnormal conditions may include the loss of data collected by one or more sensors, which may correspond to the “critical” abnormal condition as the vehicle can no longer sense its surrounding environment, thus unable to perform the autonomous driving.

It should be noted that the above description of the user interface in FIG. 8 are provided for the purposes of illustration, and is not intended to limit the scope of the present disclosure. For persons having ordinary skills in the art, multiple variations and modifications may be made under the teachings of the present disclosure. However, those variations and modifications do not depart from the scope of the present disclosure. For example, in FIG. 8, the error code may be used to not only represent the urgency degree of an abnormal condition, but also represent the type of the abnormal component.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device. Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A vehicle system, comprising:
at least one storage medium including a set of instructions; and
at least one processor in communication with the at least one storage medium, wherein when executing the instructions, the at least one processor is configured to direct the system to:
determine first status information of one or more hardware components in a vehicle, together with second status information of one or more software components in the vehicle, the one or more software components functioning at least partially depending on the one or more hardware components; and
in response to a determination that the first status information includes a first abnormal condition of the one or more hardware components, convey a first notification indicating the first abnormal condition to a passenger in the vehicle;
in response to a determination that the first status information does not include the first abnormal condition of the one or more hardware components, perform a first action;
in response to a determination that the second status information includes a second abnormal condition of the one or more software components, convey a second notification, which is distinct from the first notification, indicating the second abnormal condition to the passenger in the vehicle; and
in response to a determination that the second status information does not include the second abnormal condition of the one or more software components, perform a second action.

2. The vehicle system of claim 1, wherein the one or more hardware components include an electronic component, and wherein to determine the first status information of the electronic component, the at least one processor is configured to:
determine a voltage of the electronic component via a power supply board that is configured to supply powers to the one or more hardware components in the vehicle; and
determine the first status information of the electronic component based on the voltage of the electronic device.

3. The vehicle system of claim 2, wherein the first abnormal condition includes that the voltage of the electronic component is above or below a threshold.

4. The vehicle system of claim 1, wherein the one or more hardware components includes at least one sensor configured to monitor a surrounding of the vehicle, and wherein to determine the first status information of the at least one sensor, the at least one processor is configured to:
acquire data from the at least one sensor via a first bypass circuit coupled to the at least one sensor; and
determine the first status information of the at least one sensor based on the acquired data from the at least one sensor.

5. The vehicle system of claim 4, wherein the first abnormal condition includes a failure of one of the at least one sensor.

6. The vehicle system of claim 1, wherein the one or more software components includes an operating system implemented on at least one of the one or more hardware components.

7. The vehicle system of claim 6, wherein to determine the second status information of the operating system, the at least one processor is configured to:
identify a CPU utilization of the operating system; and
determine the second status information of the operating system based on the CPU utilization of the operation system.

8. The vehicle system of claim 6, wherein the at least one processor is configured to direct the system to:
test the operating system before switching the vehicle to an autonomous mode.

9. The vehicle system of claim 1, wherein the one or more software components includes at least one of a route planning program and a perception program.

10. The vehicle system of claim 9, wherein to determine the second status information of the route planning program or the perception program, the at least one processor is configured to:
determine whether a loss of data collected by at least one of the one or more hardware components occurs.

11. The vehicle system of claim 10, wherein the second abnormal condition includes the loss of data collected by the at least one of the one or more hardware components.

12. The vehicle system of claim 1, wherein the first notification includes an illumination of a portion of the vehicle with a preset color.

13. The vehicle system of claim 1, wherein the second notification includes a status indicator indicating an urgency degree of the second abnormal condition.

14. The vehicle system of claim 13, wherein the status indicator indicates different urgency degrees with different colors.

15. The vehicle system of claim 1, wherein the at least one processor is further configured to direct the system to:
acquire data from a control bus in the vehicle via a second bypass circuit; and
determine, by the second bypass circuit, whether the vehicle is operating in an autonomous mode based on the acquired data from the control bus.

16. A method implemented on a computing device having at least one storage device storing a set of instructions for monitoring a vehicle, and at least one processor in communication with the at least one storage device, the method comprising:
determining first status information of one or more hardware components in a vehicle, together with second status information of one or more software components in the vehicle, the one or more software components functioning at least partially depending on the one or more hardware components; and
in response to a determination that the first status information includes a first abnormal condition of the one or more hardware components, conveying a first notification indicating the first abnormal condition to a passenger in the vehicle;
in response to a determination that the first status information does not include the first abnormal condition of the one or more hardware components, performing a first action;
in response to a determination that the second status information includes a second abnormal condition of the one or more software components, conveying a second notification, which is distinct from the first notification, indicating the second abnormal condition to the passenger in the vehicle; and
in response to a determination that the second status information does not include the second abnormal condition of the one or more software components, performing a second action.

17. The method of claim 16, wherein the one or more hardware components include an electronic component, and the determining the first status information of the electronic component comprises:
determining a voltage of the electronic component via a power supply board that is configured to supply powers to the one or more hardware components in the vehicle; and
determining the first status information of the electronic component based on the voltage of the electronic device.

18. The method of claim 17, wherein the first abnormal condition includes that the voltage of the electronic component is above or below a threshold.

19. The method of claim 16, wherein the one or more hardware components includes at least one sensor configured to monitor a surrounding of the vehicle, and wherein the determining the first status information of the at least one sensor comprises:
acquiring data from the at least one sensor via a first bypass circuit coupled to the at least one sensor; and
determining the first status information of the at least one sensor based on the acquired data from the at least one sensor.

20.-30. (canceled)

31. A non-transitory computer readable medium, comprising executable instructions that, when executed by at least one processor, direct the at least one processor to perform a method for monitoring a vehicle, the method comprising:
determining first status information of one or more hardware components in a vehicle, together with second status information of one or more software components in the vehicle, the one or more software components functioning at least partially depending on the one or more hardware components; and
in response to a determination that the first status information includes a first abnormal condition of the one or more hardware components, conveying a first notification indicating the first abnormal condition to a passenger in the vehicle;
in response to a determination that the first status information does not include the first abnormal condition of the one or more hardware components, performing a first action;
in response to a determination that the second status information includes a second abnormal condition of the one or more software components, conveying a second notification, which is distinct from the first notification, indicating the second abnormal condition to the passenger in the vehicle; and
in response to a determination that the second status information does not include the second abnormal condition of the one or more software components, performing a second action.
